(19) United States
(12) Patent Application Publication
(10) Pub. No.: US 2010/0031213 A1
(43) Pub. Date: Feb. 4, 2010

(54) DESIGN INFORMATION GENERATING APPARATUS

(75) Inventors: Taketsugu KAWAMICHI, Kawasaki (JP); Eiichi Konno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/511,549

(22) Filed: Jul. 29, 2009

(30) Foreign Application Priority Data
Jul. 29, 2008 (JP) 2008-195291

(51) Int. Cl. G06F 17/50

(52) U.S. Cl. 716/8

(57) ABSTRACT

A design information generating apparatus that generates design information of a substrate includes a substrate region generating unit that generates a plurality of substrate regions in which the substrate is arranged based on a shape of the substrate included in a design condition, when the design condition of the substrate is obtained; and a design information generating unit that generates the design information by transferring the substrate generated based on the design condition to the plurality of substrate regions after at least one of the substrate regions of the plurality of the substrate regions is inverted.

### CROSS-REFERENCE TO RELATED APPLICATION

This application is based upon and claims the benefit of priority of the prior Japanese Patent Application No. 2008-195291, filed on Jul. 29, 2008, the entire contents of which are incorporated herein by reference.

### FIELD

The present invention relates to a design information generating apparatus that generates design information of a substrate.

### BACKGROUND

Recently, an information terminal such as a mobile phone has been remarkably improved in performance, and as a result the density of a printed substrate mounted on the information terminal has become higher. As the density of a printed substrate becomes higher, it becomes more difficult to manually design a printed substrate. Therefore, a Computer Aided Design (CAD) device is used to support designing a printed substrate by using a computer.

To design a printed substrate using the CAD device, a user generates units of divided substrate information by performing an operation to arrange components on a substrate and to generate wiring of the components (hereinafter referred to as “artwork design”). A unit of divided substrate information may be, for example, substrate information of a single substrate. After generating each of the units of divided substrate information, the CAD device generates final substrate information by transferring each of the units of divided substrate information to each substrate region of standard size substrate information that has been generated in advance. The final substrate information is, for example, design information of a printed substrate. The standard size substrate information is, for example, data having a plurality of substrate regions. FIG. 9 is substrate drawing corresponding to conventional design information.

As a technique for designing a substrate, there are a known technique for printing front patterns and rear patterns of a double-sided printed wiring substrate on both sides of a substrate material in point symmetry to the center of the substrate material, and a known technique for arranging each printed wiring board on a single substrate in a way that each printed wiring board is located symmetrically in lines (see, for example, Japanese Laid-open Patent Publication No. 05-21909 and Japanese Laid-open Patent Publication No. 03-190183.)

However, in the above-described conventional technique, when examining deflection or thermal stress that may occur due to stress applied to the substrate by a component mounter or reflow after producing the final substrate data to actually produce a printed substrate, the data of the substrate may need to be generated again from the beginning as a result of the examination. This may cause low operational efficiency and a low yield of substrate production.

### SUMMARY

According to an aspect of the invention, a design information generating apparatus that generates design information of a substrate includes a substrate region generating unit that generates a plurality of substrate regions in which the substrate is arranged based on a shape of the substrate included in a design condition, when the design condition of the substrate is obtained; and a design information generating unit that generates the design information by transferring the substrate generated based on the design condition to the plurality of substrate regions after at least one of the substrate regions of the plurality of the substrate regions is inverted.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a design information generating apparatus according to the embodiment,

FIG. 2 is a functional block diagram illustrating a configuration of the design information generating apparatus according to the embodiment,

FIG. 3 illustrates an example of design information generated by an editing processing unit,

FIG. 4 illustrates an example of the design information generated by the editing processing unit,

FIG. 5 illustrates an example of the design information generated by the editing processing unit,

FIG. 6 illustrates a flowchart 1 of a processing procedure of the design information generating apparatus according to the embodiment,

FIG. 7 illustrates a flowchart 2 of the processing procedure of the design information generating apparatus according to the embodiment,

FIG. 8 is a diagram illustrating a hardware configuration of the design information generating apparatus according to the embodiment, and

FIG. 9 is substrate drawing corresponding to conventional design information.

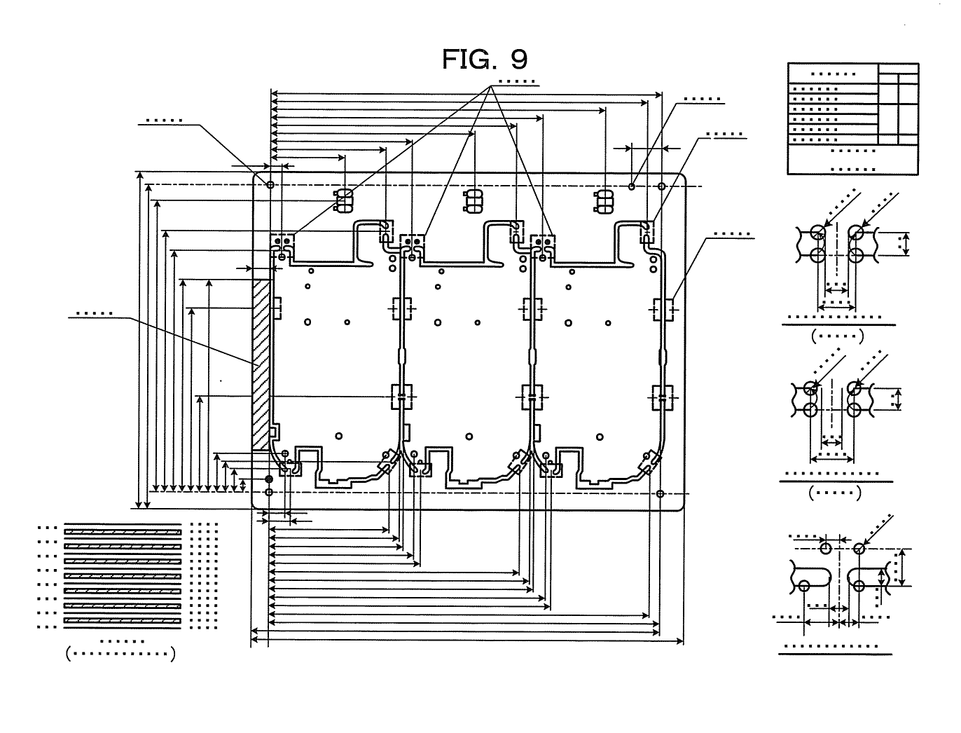

### DESCRIPTION OF EMBODIMENTS

With reference to the attached diagrams, description will made below of preferable embodiments of a design information generating apparatus according to the present invention.

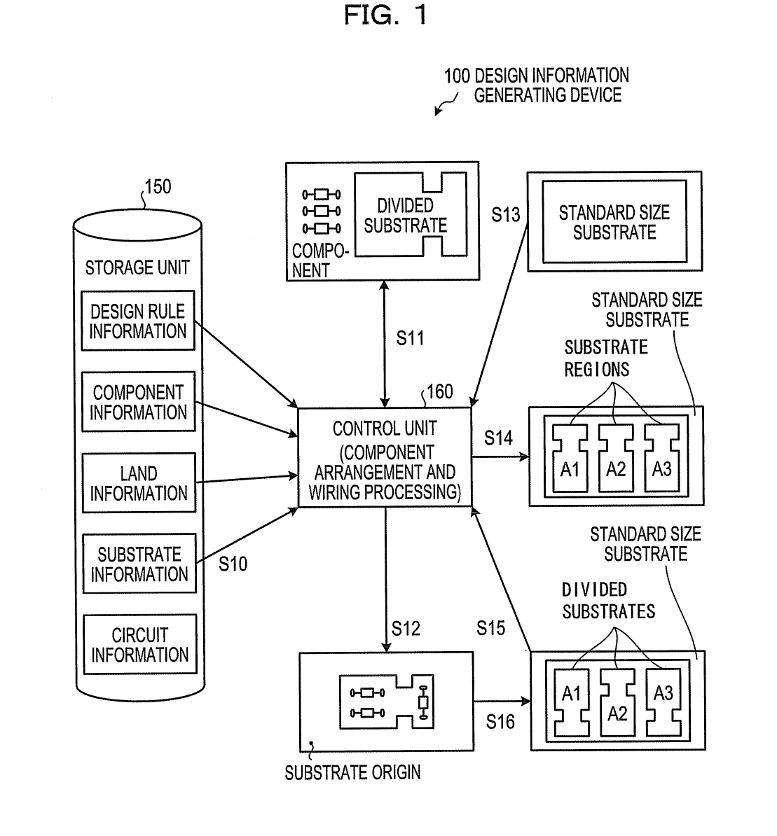

Description will be made of an overview and characteristics of the design information generating apparatus according to the embodiment. FIG. 1 is a diagram illustrating the design information generating apparatus according to the embodiment. As illustrated in FIG. 1, in a design information generating apparatus 100, a control unit 160 reads design rule information, component information, land information, substrate information, and circuit information from a storage unit 150 (step S10).

The design rule information is rule information for setting a printed substrate, such as the number of the printed substrates, a distance between a wiring and another wiring, a distance between a component and another component, and a distance between a component and a land. The component information includes a shape of the component, a land or footprint in which the component is arranged, a height at which the component is arranged, and the like.

The land information includes the shape of the land and the footprint in which the component is arranged, layers, VIAs, and the like. The substrate information includes information about a substrate, such as a substrate shape of the divided substrate, a substrate origin, and various prohibited regions. The various prohibited regions are, for example, a region in which arrangement of patterns and components is prohibited. The circuit information is circuit connection information such as a power source of a circuit, a ground, and a signal line.

The control unit 160 generates a substrate shape of a divided substrate based on the design rule information, the component information, the land information, the substrate information, and the circuit information and displays components which are to be arranged on the divided substrate (step S11). The divided substrate is substrate data of a single substrate.

The control unit 160 arranges components on the divided substrate and performs wiring processing on each of the arranged components (step S12), and reads standard size substrate information (step S13). The wiring processing may be, for example, processing for connecting components by wiring. The standard size substrate information is data having a region in which a plurality of divided substrates are arranged.

The control unit 160 blanks substrate regions A1 to A3, to which the divided substrate generated in step S12 is transferred, on the standard size substrate (step S14), and mirror-inverts an arbitrary substrate region, for example, the substrate region A2 (step S15). The control unit 160 generates design information by transferring the divided substrate to the substrate regions A1 to A3 (step S16).

In this manner, the design information generating apparatus 100 according to the embodiment generates a plurality of substrate regions on a standard size substrate according to the divided substrate and then designs a printed substrate by transferring the divided substrate to each of the substrate regions after inverting an arbitrary substrate region out of the generated substrate regions. Therefore, when a printed substrate is produced, it is possible to equalize the stress applied to the substrate when a component mounter mounts components, and to reduce warping and deflection of the substrate due to thermal stress when the substrate passes through a reflow furnace.

When producing a printed substrate, the design information generating apparatus 100 according to the embodiment may equalize the stress applied to the substrate when the component mounter mounts components, and may reduce warping and deflection of the substrate due to thermal stress when the substrate passes through the reflow furnace. Accordingly, when designing a printed substrate, the user does not need to be conscious of the stress applied to the substrate by the component mounter, deflection of the substrate by reflow, the thermal stress, or the like. Therefore, it is possible to improve the operational efficiency and the yield of the operation.

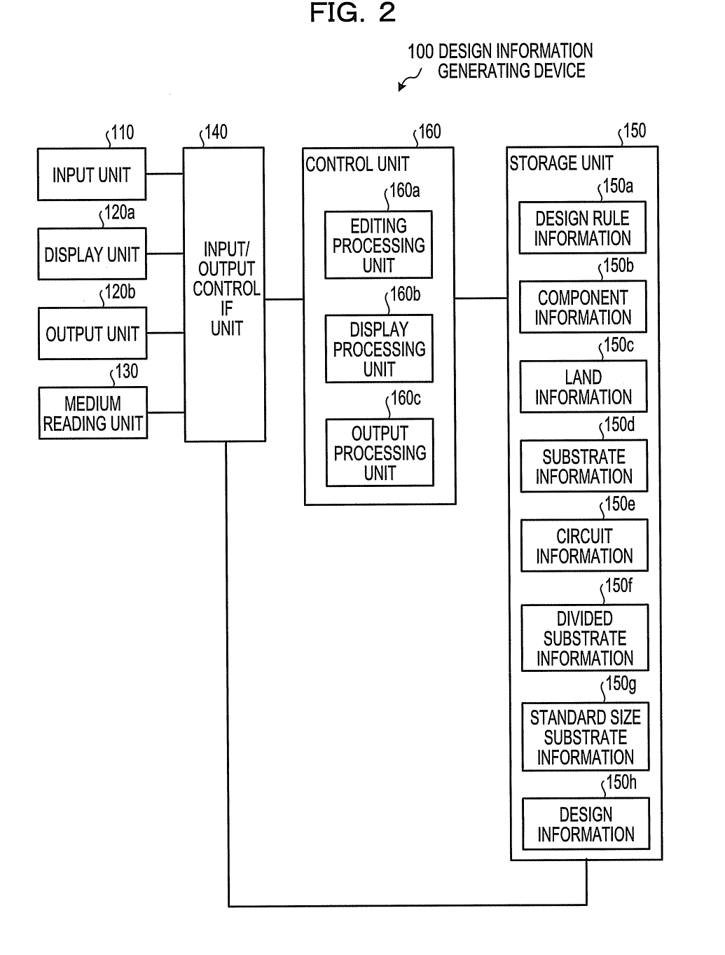

Next, description will be made of a configuration of the design information generating apparatus 100 illustrated in FIG. 1. FIG. 2 is a functional block diagram illustrating a configuration of a design information generating apparatus according to the embodiment. As illustrated in FIG. 2, the design information generating apparatus 100 includes an input unit 110, a display unit 120a, an output unit 120b, a medium reading unit 130, an input/output control IF unit 140, a storage unit 150, and a control unit 160.

The input unit 110 inputs various types of information, which is information of a substrate and corresponds to a keyboard, a mouse, a tablet, or the like. The display unit 120a described below achieves a pointing device function by being operated in cooperation with a mouse.

The display unit 120a displays various types of information and corresponds to a display or a monitor or a touch panel or the like. The output unit 120b outputs various types of information and corresponds to a printer, a plotter, or the like.

The medium reading unit 130 reads information from an external storage device. The external storage device includes a flexible disk (FD), a memory, or the like. The input/output control IF unit 140 controls input and output of data by the input unit 110, the display unit 120a, the output unit 120b, the medium reading unit 130, the storage unit 150, and the control unit 160.

The storage unit 150 stores data and programs for various processes to be performed by the control unit 160. As illustrated in FIG. 2, the storage unit 150 has design rule information 150a, component information 150b, land information 150c, substrate information 150d, circuit information 150e, divided substrate information 150f, standard size substrate information 150g, and design information 150h.

The design rule information 150a, the component information 150b, the land information 150c, the substrate information 150d, and the circuit information 150e correspond to the design rule information, the component information, the land information, the substrate information, and the circuit information illustrated in FIG. 1, respectively.

The divided substrate information 150f is information of a divided substrate generated based on the design rule information 150a, the component information 150b, the land information 150c, the substrate information 150d, and the circuit information 150e. The divided substrate information corresponds to the information generated in step S11 and step S12 of FIG. 1.

The standard size substrate information 150g is information of a standard size substrate in which a plurality of divided substrates are arranged. The example of the standard size substrate illustrated in FIG. 1 includes three regions in which divided substrates are arranged. Hereinafter, a region in which the divided substrates on the standard size substrate are transferred is indicated as a substrate region.

The design information 150h is generated by transferring the divided substrates to the substrate region on the standard size substrate.

The control unit 160 includes an internal memory that stores programs and control data specifying various processing procedures and performs various processes by using those programs and data. As illustrated in FIG. 2, the control unit 160 includes an editing processing unit 160a, a display processing unit 160b, and an output processing unit 160c.

The editing processing unit 160a generates a divided substrate based on the design rule information 150a, the component information 150b, the land information 150c, the substrate information 150d, and the circuit information 150e. The editing processing unit 160a also generates a plurality of substrate regions on the standard size substrate based on the shape of the divided substrate, and then generates the design information 150h by transferring the divided substrate after inverting part of the substrate regions.

Detailed description will be made below of processing of the editing processing unit 160a. The editing processing unit 160a reads the design rule information 150a, the component information 150b, the land information 150c, the substrate information 150d, and the circuit information 150e, displays each of the read data on the display unit 120b, generates and edits the substrate shape in cooperation with a user who operates the input unit 110, and generates the divided substrate information 150f by performing component arrangement and wiring processing on the substrate.

The editing processing unit 160a reads the design rule information 150a, the component information 150b, the land information 150c, the substrate information 150d, and the circuit information 150e, and may automatically generate the divided substrate information 150f by a known technique. The editing processing unit 160a arranges positioning marks for a metal mask in arbitrary positions of the divided substrate. The user may previously input, to the editing processing unit 160a, the information of the positions in which the positioning marks, which are coordinates on the divided substrate, are arranged.

The editing processing unit 160a generates a substrate region on the standard size substrate based on the shape of the divided substrate, the shape of the standard size substrate, and a blanking condition. Hereinafter, the shape of the divided substrate is referred to as divided substrate size data, and the shape of the standard size substrate is referred to as standard size data. The blanking condition includes a region of perforations for cutting the divided substrates after generation of the substrates and information of a router drill. The editing processing unit 160a generates a plurality of substrate regions on the standard size substrate according to the blanking condition.

After generating the substrate regions on the standard size substrate, the editing processing unit 160a determines the substrate region to be inverted and the direction to be inverted. The directions to be inverted are, for example, up and down, and right and left. In this case, the substrate region to be inverted and the direction to be inverted may be selected by a user accordingly, or may be automatically determined by the editing processing unit 160a based on the condition of the substrate information for inversion. For example, FIG. 1 illustrates the condition for inverting the substrate region A2 up and down if three substrate regions are arranged.

The editing processing unit 160a inverts the coordinates of the substrate region based on the substrate information for inversion and the direction to be inverted. For example, if the coordinates (A, B) on the substrate region are inverted (180-degree rotation), the coordinates after the inversion become the coordinates (−A, B). Furthermore, if the coordinates (A, B) on the substrate region are inverted upside down (90-degree rotation), the coordinates after the inversion become the coordinates (A, −B).

The editing processing unit 160a makes a duplicate copy of the divided substrate information 150f and inverts the coordinates on the divided substrate, the positions of components, the position of wiring, and the like with respect to the duplicate divided substrate information 150f in the same way as above.

The editing processing unit 160a generates the design information 150h by transferring the divided substrates to each of the substrate regions on the standard size substrate. The uninverted divided substrate information is transferred to the uninverted substrate region, and the inverted divided substrate information is transferred to the inverted substrate region. The surface or back surface of the divided substrate is transferred to each of the substrate regions.

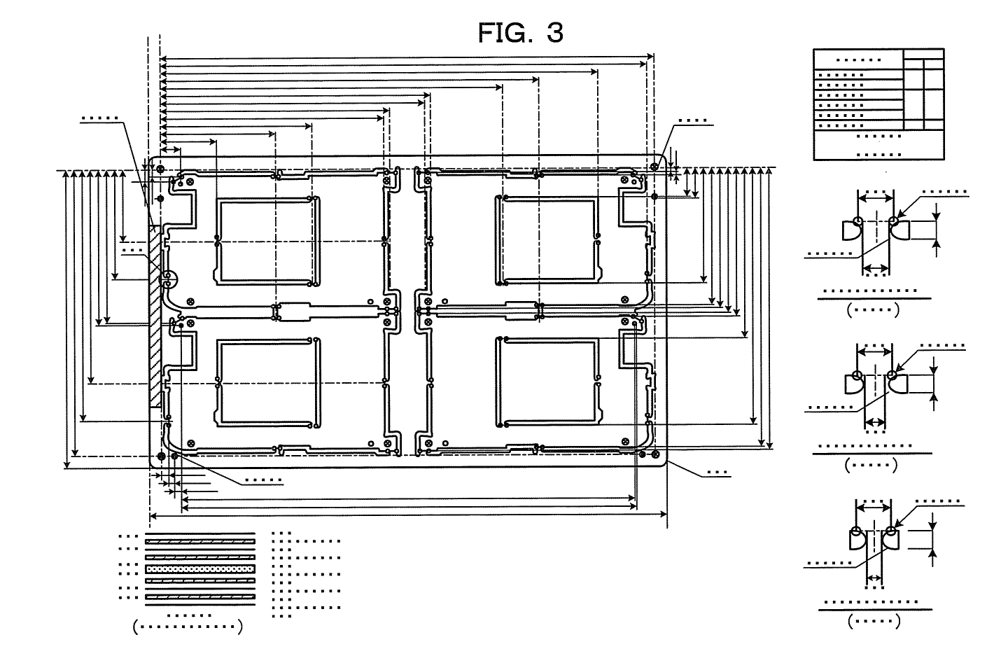

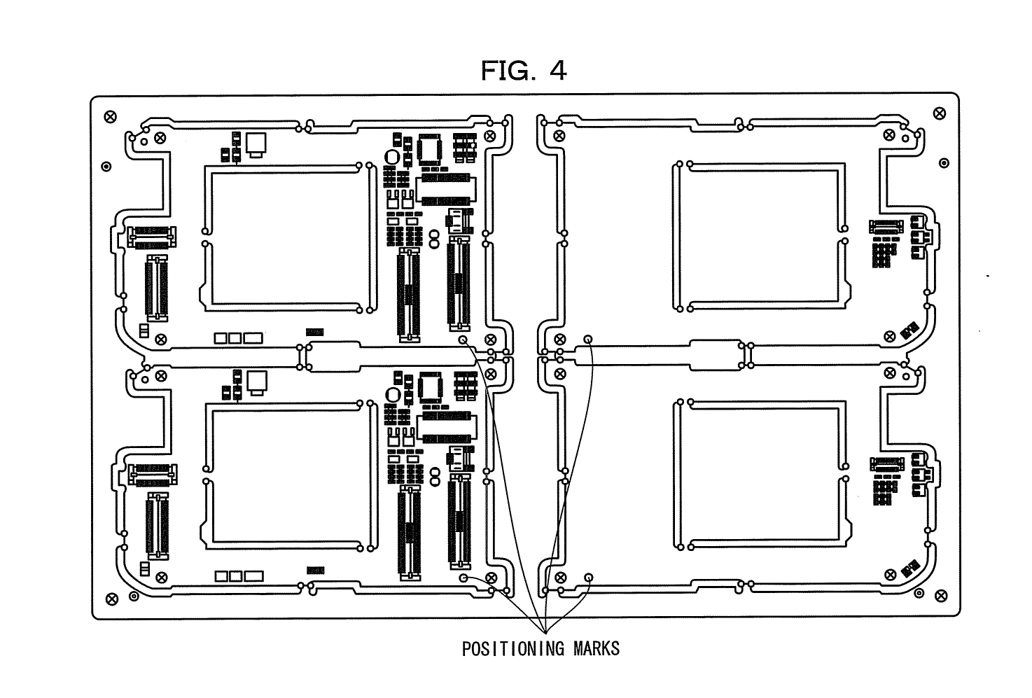

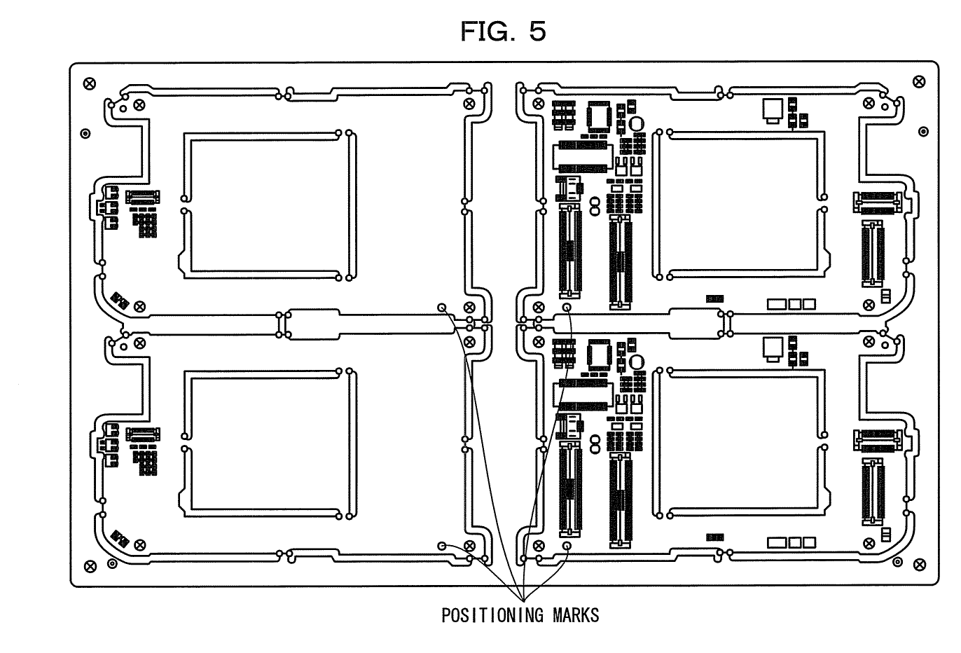

FIG. 3, FIG. 4, and FIG. 5 illustrate examples of the design information 150h generated by the editing processing unit 160a. In the example illustrated in FIG. 3, four substrate regions are disposed on the standard size substrate. After the substrate regions in the left side of the first stage and second stage are inverted right and left, the back surface of the divided substrate is transferred.

In the example illustrated in FIG. 4, four substrate regions are disposed on the standard size substrate. After the substrate regions in the left side of the first stage and second stage are inverted right and left, the divided substrate is transferred. The surface of the divided substrate is transferred to the substrate region on the left side, and the back surface of the divided substrate is transferred to the substrate region on the right side.

In the example illustrated in FIG. 5, four substrate regions are disposed on the standard size substrate. After the substrate regions in the left side of the first stage and second stage are inverted right and left, the divided substrate is transferred. The back surface of the divided substrate is transferred to the substrate region on the left side, and the surface of the divided substrate is transferred to the substrate region on the right side.

In FIG. 4 and FIG. 5, positioning marks are arranged in the same position of the surface and back surface of the substrate. In this manner, by arranging the positioning marks for the metal mask in the same position of the surface and back surface of the substrate, a single substrate can produce a metal mask in the mounting time of components. This makes it possible to reduce the production costs of the metal mask, because two substrates of the surface and the back surface are necessary in the conventional technique.

In FIG. 2, the display processing unit 160b displays the divided substrate information 150g generated by the editing processing unit 160a, the standard size substrate information 150g that includes the substrate region, and the like on the display unit 120a. The user refers to the divided substrate displayed on the display unit 120a and uses the input unit 110 to correct the divided substrate. The information of the corrected divided substrate is input to the editing processing unit 160a through the input unit 110. Hereinafter, the information of the corrected divided substrate is referred to as divided substrate correction information. The editing processing unit 160a updates the divided substrate information 150f corresponding to the divided substrate correction information.

The user refers to the substrate region on the standard size substrate displayed on the display unit 120a and uses the input unit 110 to select the substrate region to be inverted. The information of the selected substrate region is input to the editing processing unit 160a through the input unit 110.

The output unit 120b outputs the design information 150h generated by the editing processing unit 160a to the output unit 120b.

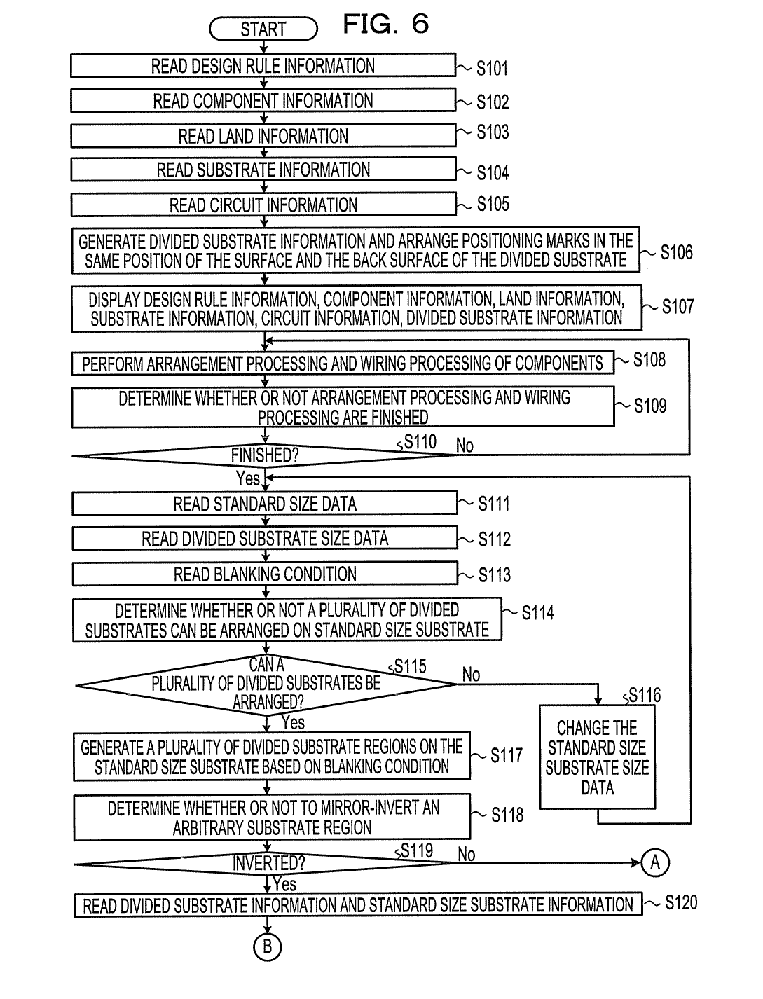

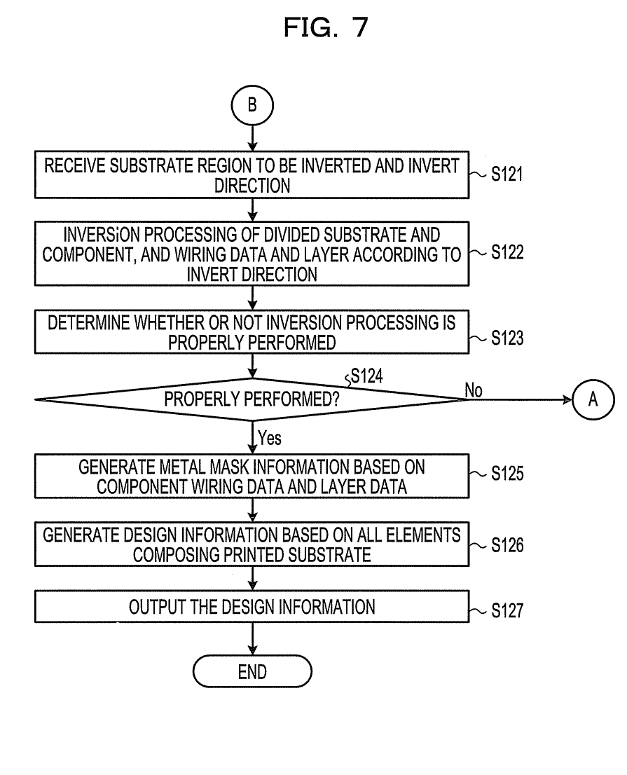

Next, description will be made of a processing procedure of the design information generating apparatus 100 according to the embodiment. FIG. 6 and FIG. 7 are flowcharts illustrating the processing procedure of the design information generating apparatus 100 according to the embodiment. As illustrated in FIG. 6, in the design information generating apparatus 100, the editing processing unit 160a reads the design rule information 150a (step S101), reads the component information 150b (step S102), reads the land information 150c (step S103), reads the substrate information 150d (step S104), and reads the circuit information 150e (step S105).

The editing processing unit 160a generates the divided substrate information 150f and arranges positioning marks in the same position of the surface and back surface of the divided substrate (step S106), and the display processing unit 160b displays the design rule information 150d, the component information 150d, the land information 150c, the circuit information 150e, and the divided substrate information 150f on the display unit 120a (step S107).

The editing processing unit 160a performs arrangement processing and wiring processing of components (step S108), and then determines whether or not the arrangement processing and the wiring processing are finished (step S109). If the arrangement processing and the wiring processing are not finished (No at step S110), the process moves to step S108.

If the arrangement processing and the wiring processing are finished (Yes at step S110), the editing processing unit 160a reads the standard size data (step S111), reads the divided substrate size data (step S112), and reads the blanking condition (step S113).

The editing processing unit 160a determines whether or not a plurality of divided substrates may be arranged on the standard size substrate (step S114). If the plurality of divided substrates are not able to be arranged (No at step S115), the editing processing unit 160a changes the standard size data (step S116). Then the process moves to step S111.

If the plurality of divided substrates are able to be arranged on the standard size substrate (Yes at step S115), the editing processing unit 160a generates a plurality of substrate regions on the standard size substrate based on the blanking condition (step S117) and determines whether or not to mirror-invert an arbitrary substrate region (step S118).

If the arbitrary substrate region is not mirror-inverted (No at step S119), the process goes to step S125. On the other hand, if the arbitrary substrate region is mirror-inverted (Yes at step S119), the editing processing unit 160a reads the divided substrate information 150f and the standard size substrate information 150g (step S120), and then receives a substrate region to be inverted and an invert direction (step S121).

The editing processing unit 160a inverts the divided substrate and the component and inverts the wiring data and the layer according to the invert direction (step S122), and determines whether or not the inversion processing is properly performed (step S123). If the inversion processing is not properly performed (No at step S124), the process moves to step S121.

If the inversion processing is properly performed (Yes at step S124), the editing processing unit 160a generates metal mask information based on component wiring data and layer data (step S125), generates the design information 150h based on all the elements composing a printed substrate (step S126), and outputs the design information 150h (step S127).

As described above, in the design information generating apparatus 100 according to the embodiment, the editing processing unit 160a generates the divided substrate information 150f based on the design rule information 150a, the component information 150b, the land information 150c, the substrate information 150d, the circuit information 150e, generates a plurality of substrate regions on the standard size substrate, and designs a printed substrate by transferring the divided substrate to each substrate region after inverting an arbitrary substrate region of the generated substrate regions. The arbitrary substrate region may be, for example, a substrate region between other substrate regions. Thus, at the time of producing printed substrates, it is possible to equalize the stress applied to the substrate and to reduce warping or deflection of the substrate due to thermal stress when the substrate passes through the reflow furnace.

Of the processing described in the embodiments, all or part of the processing to be automatically performed may be manually performed, or all or part of the processing to be manually performed may be automatically performed by a known method. In addition, the information that includes the processing procedure, control procedure, specific names, various data and parameters described above or illustrated in the diagrams may be changed arbitrarily except if not otherwise specified.

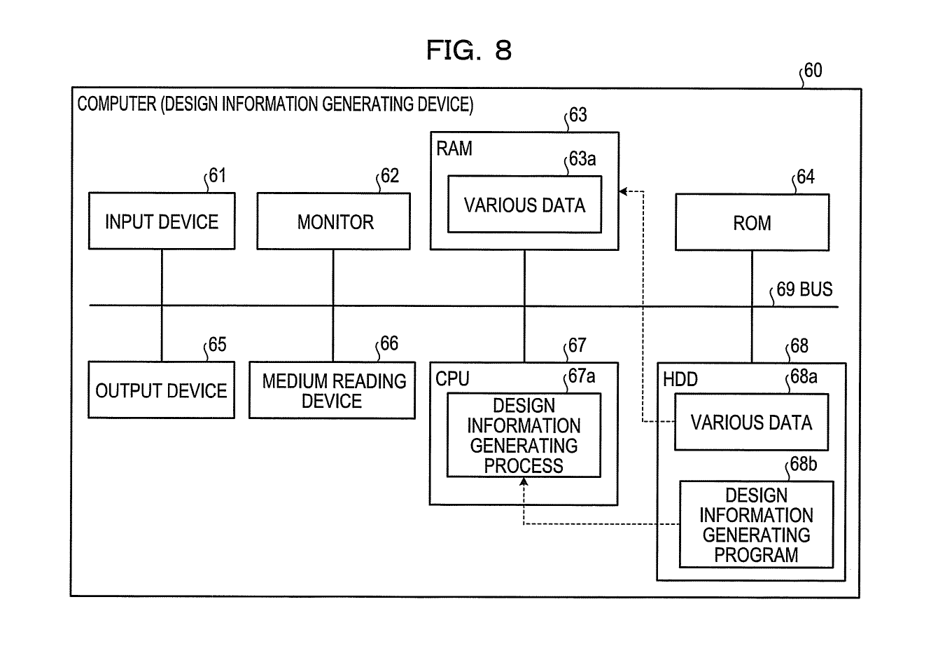

FIG. 8 is a diagram illustrating a hardware configuration of the design information generating apparatus 100 according to the embodiment. As illustrated in FIG. 8, in a computer 60 corresponding to the design information generating apparatus 100, an input device 61, a monitor 62, a Random Access Memory (RAM) 63, a Read Only Memory (ROM) 64, an output device 65 such as a printer, a medium reading device 66 that reads data from a storage medium, a Central Processing Unit (CPU) 67, and a Hard Disk Drive (HDD) 68 are connected to each other via a bus 69.

The HDD 68 stores a design information generating program 68b that executes the same functions as that of the above-described design information generating apparatus 100. The CPU 67 reads out and executes the design information generating program 68b. This starts a design information generating process 67a. The design information generating process 67a corresponds to the editing processing unit 160a, the display processing unit 160b, and the output processing unit 160c illustrated in FIG. 2.

The HDD 68 stores various data 68a corresponding to each of the data 150a to the data 150h stored in the storage unit 150 of the embodiment. The CPU 67 reads out the various data 68a stored in the HDD 68 to the RAM 63 and generates design information based on the various data 63a.

The design information generating program 68b may not be stored in the HDD 68 from the beginning. The design information generating program 68b may be stored in, for example, a “portable physical medium” such as a flexible disk (FD), a CD-ROM, a DVD disk, a magneto optical disk, and an IC card to be inserted in a computer, a “fixing physical medium” such as a hard disk drive (HDD) to be provided inside or outside the computer, or “another computer (or server)” to be connected to a computer through a public line, Internet, LAN, WAN, or the like. Then the computer may read out and execute the design information generating program 68b from the above-described medium or computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it may be understood that the various changes, substitutions, and alterations could be made hereto without departing from the spirit and scope of the invention.

What is claimed is:

1. A design information generating apparatus that generates design information of a substrate, the design information generating apparatus comprising:
a substrate region generating unit that generates a plurality of substrate regions in which the substrate is arranged based on a shape of the substrate included in a design condition, when the design condition of the substrate is obtained; and
a design information generating unit that generates the design information by transferring the substrate generated based on the design condition to the plurality of substrate regions after at least one of the substrate regions of the plurality of the substrate regions is inverted.

2. The design information generating apparatus according to claim 1, wherein the substrate region generating unit obtains information of a standard size substrate in which the plurality of substrates are arranged, and generates the plurality of substrate regions based on the information of the standard size substrate.

3. The design information generating apparatus according to claim 1, wherein the substrate region generating unit outputs the plurality of substrate regions onto a screen, and when a substrate region to be inverted is selected, the design information generating unit inverts the selected substrate region.

4. The design information generating apparatus according to claim 1 wherein the design information generating unit transfers a surface and a back surface of the substrate designed by the design condition to the plurality of substrate regions.

5. The design information generating apparatus according to claim 1 wherein the design information generating unit transfers a surface or a back surface of the substrate designed by the design condition to the plurality of substrate regions.

6. The design information generating apparatus according to claim 4, wherein the design information generating unit transfers the surface and the back surface of the substrate designed by the design condition to the plurality of substrate regions and arranges positioning marks for a metal mask on the surface and the back surface of the substrate.

7. The design information generating apparatus according to claim 5, wherein the design information generating unit transfers the surface or the back surface of the substrate designed by the design condition to the plurality of substrate regions and arranges positioning marks for a metal mask on the surface or the back surface of the substrate.

8. A method for generating design information comprising:
generating a plurality of substrate regions in which a substrate is arranged based on a shape of the substrate included in a design condition, when the design condition of the substrate is obtained; and
generating the design information by transferring the substrate generated by the design condition to the plurality of substrate regions after at least one of the substrate regions is inverted.

9. The design information generating method according to claim 8, wherein information of a standard size substrate in which the plurality of substrates are arranged is obtained and the plurality of substrate regions are generated based on the information of the standard size substrate.

10. The design information generating method according to claim 8, wherein the plurality of substrate regions are output onto a screen, and when a substrate region to be inverted is selected, the selected substrate region is inverted.

11. The design information generating method according to claim 8, wherein the surface and back surface of the substrate generated by the design condition are transferred to the plurality of substrate regions.

12. The design information generating method according to claim 8, wherein the surface or back surface of the substrate generated by the design condition is transferred to the plurality of substrate regions.

13. The design information generating method according to claim 11, wherein the surface and the back surface of the substrate generated based on the design condition to the plurality of substrate regions, and positioning marks for a metal mask are arranged on the surface and the back surface.

14. A computer-readable recording medium storing a program that causes a computer to generate design information, the program causing the computer to execute:
generating a plurality of substrate regions in which a substrate is arranged based on a shape of the substrate included in a design condition, when the design condition of the substrate is obtained; and
generating the design information by transferring the substrate generated by the design condition to the plurality of substrate regions after at least one of the substrate regions is inverted.

15. The computer-readable recording medium according to claim 14, wherein information of a standard size substrate in which the plurality of substrates are arranged is obtained and the plurality of substrate regions are generated based on the information of the standard size substrate.

16. The computer-readable recording medium according to claim 14, wherein the plurality of substrate regions are output onto a screen, and, when a substrate region to be inverted is selected, the selected substrate region is inverted.

17. The computer-readable recording medium according to claim 14, wherein the surface and the back surface of the substrate designed by the design condition are transferred to the plurality of substrate regions.

18. The computer-readable recording medium according to claim 14, wherein the surface or the back surface of the substrate designed by the design condition is transferred to the plurality of substrate regions.

19. The computer-readable recording medium according to claim 14, wherein the surface and the back surface of the substrate designed by the design condition and transferred to the plurality of substrate regions and the positioning marks for a metal mask are arranged on the surface and the back surface.
